(19) United States
(12) Patent Application Publication
(10) Pub. No.: US 2024/0223097 A1
(43) Pub. Date: Jul. 4, 2024

(54) DUAL-ACTIVE BRIDGE CONVERTER AND APPLICATIONS OF SAME

(71) Applicant: McMaster University, Hamilton (CA)

(72) Inventors: Omar Zayed, Hamilton (CA); Ahmed Elezab, Hamilton (CA); Mehdi Narimani, Oakville (CA)

(21) Appl. No.: 18/541,124

(22) Filed: Dec. 15, 2023

Related U.S. Application Data
(60) Provisional application No. 63/435,087, filed on Dec. 23, 2022.

(51) Int. Cl. H02M 3/335; B60L 53/22; H02J 7/02; H02M 1/00

(52) U.S. Cl. CPC H02M 3/33584; B60L 53/22; H02J 7/02; H02M 1/007; H02M 3/33573; B60L 2210/10

(57) ABSTRACT

A dual-active bridge (DAB) converter is provided. The DAB converter comprises a primary sub-circuit coupled to a direct-current (DC) input voltage, a first secondary sub-circuit and a second secondary sub-circuit, and a transformer isolating the primary sub-circuit from the first and the second secondary sub-circuits and comprising a predetermined number of turns. Each of the first and the secondary sub-circuits comprise a corresponding inductor; the first and the second secondary sub-circuits being configurable in a series mode and a parallel mode by switching configurations of a first, second and third transition switch; and the first and the second secondary sub-circuits providing an output charging voltage and an output charging current for charging an external device. A charging station comprising one or more charging poles, with each charging pole comprising one of more DAB converters is also disclosed.

### CROSS REFERENCE TO RELATED APPLICATION

The present disclosure claims priority from U.S. provisional application No. 63/435,087 filed on Dec. 23, 2022, which is hereby incorporated by reference in its entirety.

### FIELD

The described embodiments generally relate to an improved dual-active bridge converter and applications of the same.

### BACKGROUND

The transportation sector is a significant contributor to global greenhouse gas emission. Internal combustion engines of motor vehicles burn fossil fuels like gasoline and diesel to drive the vehicles and generate greenhouse gas emissions in the process. The greenhouse gas emission of the transportation sector can be reduced by using electric vehicles instead of internal combustion engine-based motor vehicles. However, despite the push to electrification, two of the main challenges standing in the way are widely available, cost-effective electric vehicle service equipment (EVSE) and the decarbonization of power generation. Increased use of direct current (DC)-connected charging stations may be the key to electrification and the wide adoption of electric vehicles. Accordingly, improvements to the DC-connected charging stations are needed.

### SUMMARY

The following summary is provided to introduce the reader to the more detailed discussion to follow. The summary is not intended to limit or define any claimed or as yet unclaimed invention. One or more inventions may reside in any combination or sub-combination of the elements or process steps disclosed in any part of this document including its claims and figures.

According to some aspects, a wide output voltage range charging module for ultra-fast DC-connected charging stations is provided. The charging module comprises a dual-active bridge (DAB) converter in accordance with the embodiment described herein. The DAB converter includes a primary sub-circuit and two secondary sub-circuits coupled via a transformer with a turning ratio of n. Each of the two secondary sub-circuits include a respective inductor, Lₛₕᵢₘ.

According to the various embodiments illustrated herein, the DAB converter can transition between a series mode and a parallel mode. The DAB converter can be used in the series mode for voltage sharing in high output voltage operations, and in the parallel mode for current sharing in high power operations.

In the various embodiments disclosed herein, the wide output voltage range of the DAB converter can extend from 200V to 1000V at a power level of 10 kW. In addition, the DAB converters can be stacked to increase the charging power to ultra-fast power levels, such as, for example, power levels above 350 kW.

According to some aspects, a charging station is provided. The charging station comprises one or more charging poles, and each charging pole comprises one or more DAB converter modules in accordance with the embodiment described herein. The one or more DAB converter modules of each charging pole can be connected in parallel to accommodate a wide range of voltage and power needs of electric vehicles.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a schematic view of a direct current (DC)-connected charging station in accordance with an embodiment.

FIG. 2A is a schematic view of a dual-active bridge (DAB) converter according to an embodiment.

FIG. 2B is a schematic view of a DAB converter according to another embodiment.

FIG. 2C is a schematic view of a DAB converter according to a further embodiment.

FIG. 3 is a schematic view of a state machine model of a DAB converter according to an example embodiment.

FIG. 4A is a schematic view of a three-voltage source model of a DAB converter according to an example embodiment.

FIG. 4B is a schematic view of a two-voltage source equivalent current model of the DAB converter of FIG. 4A according to an example embodiment.

FIG. 4C is a graphical representation of DAB converter parameters of FIG. 4B according to an example embodiment.

FIG. 4D is a schematic view of a source equivalent model of the DAB converter of FIG. 4A according to an example embodiment.

FIG. 4E is a schematic view of a source equivalent model of the DAB converter of FIG. 4D according to an example embodiment.

FIG. 5 is a graphical representation of a current sharing error of the DAB converter according to an example embodiment.

FIG. 6 is a graphical representation of a root mean square (RMS) current map of the DAB converter according to an example embodiment.

FIG. 7 is a graphical representation of an RMS current map of the DAB converter according to another example embodiment.

FIG. 8 is a graphical representation of an RMS current map of the DAB converter according to a further example embodiment.

FIG. 9 is a graphical representation of DAB converter parameters according to an example embodiment.

FIG. 10 is a graphical representation of quantized energy profiles of a DAB converter according to an example embodiment.

FIG. 11 is a flow diagram depicting a method of determining parameters of a DAB converter according to an example embodiment.

FIG. 12 is a graphical representation of a weighted total energy efficiency map of a DAB converter according to an example embodiment.

FIG. 13 is a graphical representation of optimal flux density of transformer of a DAB converter according to an example embodiment.

FIG. 14 is a schematic view of a transformer of a DAB converter according to an example embodiment.

FIG. 15 is a schematic view of an experimental setup of a DAB converter according to an example embodiment.

FIG. 16A is a graphical representation of DAB converter parameters according to an example embodiment.

FIG. 16B is a graphical representation of DAB converter parameters according to another example embodiment.

FIG. 16C is a graphical representation of DAB converter parameters according to a further example embodiment.

FIG. 17A is a graphical representation of DAB converter parameters according to an example embodiment.

FIG. 17B is a graphical representation of DAB converter parameters according to another example embodiment.

FIG. 17C is a graphical representation of DAB converter parameters according to a further example embodiment.

FIG. 18 is a graphical representation of DAB converter efficiency according to an example embodiment.

FIG. 19 is a graphical representation of DAB converter efficiency according to another example embodiment.

FIG. 20 is a graphical representation of DAB converter efficiency according to a further example embodiment.

### DETAILED DESCRIPTION

Numerous embodiments are described in this application and are presented for illustrative purposes only. The described embodiments are not intended to be limiting in any sense. The invention is widely applicable to numerous embodiments, as is readily apparent from the disclosure herein. Those skilled in the art will recognize that the present invention may be practiced with modification and alteration without departing from the teachings disclosed herein. Although particular features of the present invention may be described with reference to one or more particular embodiments or figures, it should be understood that such features are not limited to usage in the one or more particular embodiments or figures with reference to which they are described.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

As used herein and in the claims, two or more parts are said to be “coupled”, “connected”, “attached”, “joined”, “affixed”, or “fastened” where the parts are joined or operate together either directly or indirectly (i.e., through one or more intermediate parts), so long as a link occurs. As used herein and in the claims, two or more parts are said to be “directly coupled”, “directly connected”, “directly attached”, “directly joined”, “directly affixed”, or “directly fastened” where the parts are connected in physical contact with each other. As used herein, two or more parts are said to be “rigidly coupled”, “rigidly connected”, “rigidly attached”, “rigidly joined”, “rigidly affixed”, or “rigidly fastened” where the parts are coupled so as to move as one while maintaining a constant orientation relative to each other. None of the terms “coupled”, “connected”, “attached”, “joined”, “affixed”, and “fastened” distinguish the manner in which two or more parts are joined together.

Further, although method steps may be described (in the disclosure and/or in the claims) in a sequential order, such methods may be configured to work in alternate orders.

In other words, any sequence or order of steps that may be described does not necessarily indicate a requirement that the steps be performed in that order. The steps of methods described herein may be performed in any order that is practical. Further, some steps may be performed simultaneously.

As used herein and in the claims, a group of elements are said to ‘collectively’ perform an act where that act is performed by any one of the elements in the group, or performed cooperatively by two or more (or all) elements in the group.

As used herein and in the claims, a first element is said to be “received” in a second element where at least a portion of the first element is received in the second element unless specifically stated otherwise.

Some elements herein may be identified by a part number, which is composed of a base number followed by an alphabetical or subscript-numerical suffix (e.g., 112a, or 112₁). Multiple elements herein may be identified by part numbers that share a base number in common and that differ by their suffixes (e.g., 112₁, 112₂, and 112₃). All elements with a common base number may be referred to collectively or generically using the base number without a suffix (e.g., 112).

There can be several barriers to the widespread adoption of electric vehicles (EVs). One such barrier is the lack of an ultra-fast and efficient EV charging solution. Another barrier is the lack of a cost-effective charging solution. DC-connected charging stations, in contrast to AC-connected charging stations, have been recognized to provide many advantages. For example, DC-connected charging stations can promote decarbonization by, for example, allowing the integration of renewable energy sources (RESs). DC-connected charging stations also tend to have fewer conversion stages compared to AC-connected stations, thereby reducing overall system cost by, for example, being smaller and more efficient.

However, conventional AC and DC-connected solutions still have some disadvantages. For example, such solutions generally: i) tend to be limited multi-stage AC-connected stations, ii) fall short in efficiently covering a wide output voltage range, iii) require high number of components and/or devices with high kVA rating, iv) tend to be non-isolated, thus contradicting current charging standards, and/or v) tend to be unidirectional, thereby preventing vehicle-to-grid (V2G) capability. In addition, most AC-connected solutions cannot be utilized for DC-connected stations since each front-end stage assists in regulating the output charging voltage. However, this cannot be realized in DC-connected stations due to a shared front-end. Accordingly, even with the use of AC and/or DC-connected charging stations, challenges remain with increasing the adaptability of the station so that it can accommodate the diverse charging needs of various vehicle types.

Described herein is an improved bidirectional DC/DC charging converter to address some of the disadvantages associated with conventional AC and/or DC charging stations. The proposed charging converter is a dual-active bridge (DAB) converter that provides the advantages of being modular, offering a wide output voltage range, all while maintaining an overall high efficiency and device utilization. In the various embodiments disclosed herein, the DAB converter provides the advantage of maintaining a high efficiency and performance throughout the charging duration and over a wide output voltage range, as opposed to only specific instants in time and/or at specific output voltage points. The DAB converter of the various embodiments disclosed herein is a single-stage converter. As well, the DAB converter of the various embodiments disclosed herein is an isolated converter that does not require any regulation assistance.

In the various embodiments disclosed herein, the proposed DAB converter can connect directly to the fixed DC-bus of the charging station. In some cases, the DC-bus can be supplied by a two-stage low-frequency transformer and central front-end rectifier stage. In some other cases, the DC-bus can be supplied by a smaller, more efficient single-stage solid-state transformer (SST).

In some embodiments, the DAB converter disclosed herein is used in EV charging stations. In some other embodiments, the DAB converter disclosed herein is used as an on-board EV charger. In some further embodiments, the DAB converter disclosed herein is used for remote or off-grid charging applications. The DAB converter disclosed herein can be used as a single module or in combination with other modules.

The wide voltage range of the DAB converter disclosed in the various embodiments herein may be critical for future proofing stations to support existing and next generation EVs. In various embodiments, selection of the DAB converter parameters is based on an energy-based optimization strategy that considers the full range of charging scenarios of the DAB converter. In some cases, the energy-based optimization is based on data collected from actual EV charging sessions. In some other cases, the energy-based optimization is based on data collected from simulations of EV charging sessions.

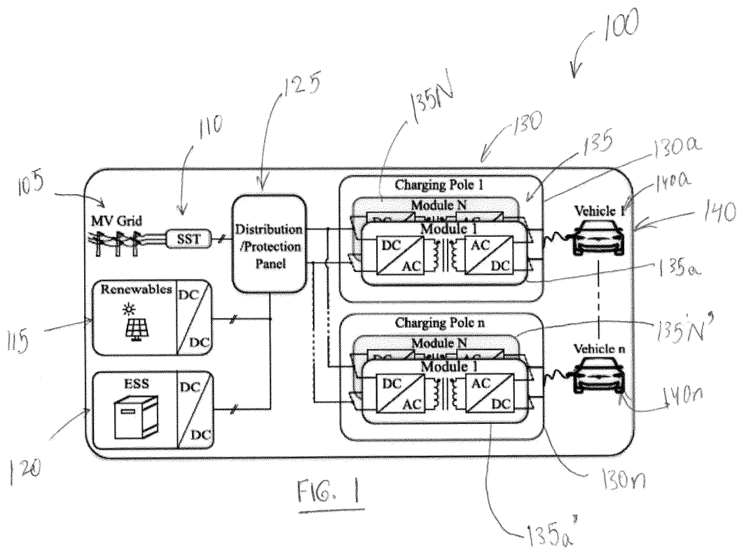

Reference is made to FIG. 1, which illustrates a schematic view of a DC-connected charging station 100 in accordance with an example embodiment. Charging station 100 consists of a medium voltage (MV) grid 105, a SST 110, a renewable power source(s) 115, an energy storage system (ESS) 120, a distribution panel 125, a plurality of charging poles 130, a plurality of DAB converters 135 and a plurality of vehicles 140.

The plurality of charging poles 130 are equipped with one or more DAB converters to charge one or more electric vehicles 140 at any given time. For example, as illustrated, charging pole 130a consists of ‘N’ dual-active bridge converters 135a, . . . , 135N. Similarly, charging pole 130n consists of ‘N’ dual-active bridge converters 135a′, . . . , 135N′. Vehicle 140a can be charged using the DAB converter 135a at charging pole 130a, and vehicle 140n can be charged using dual-active bridge converter 135a′ at charging pole 130n.

In the various embodiments disclosed herein, each DAB converter 135 can have a universal output voltage range. For example, in some cases, the universal output voltage range can extend from 200V to 1000V at a power level of 10 kW. In some embodiments, the DAB converters 135 of each charging pole 130 can be combined in parallel to increase the charging power to ultra-fast power levels, such as, for example, power levels above 350 kW.

Table I shows an example of various vehicle types 140 and corresponding battery voltage needs.

TABLE I
ELECTRIC VEHICLE BATTERIES

| | | Battery Voltage |
|---|---|---|
| Vehicle Type | OEM-Model | [V] |
| Sedan | Nissan-Leaf | *360 |
| | Tesla-Model S | *450 |
| Bus | Volvo-7900 Electric | *690 |
| Supercar | Porsche-Tycan | *723 |
| Hypercar | Rimac-Nevera | **730 |
| Aircraft | Rolls Royce-Spirit of Innovation | *750 |

*Nominal Voltage,
**Max Voltage.

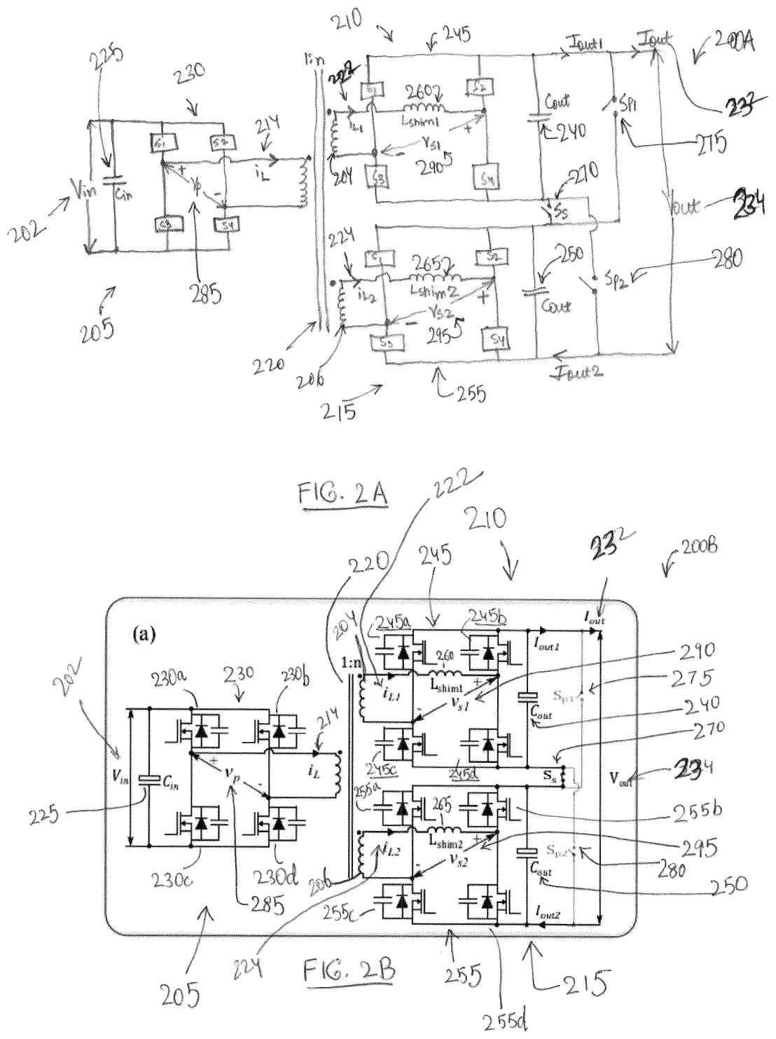

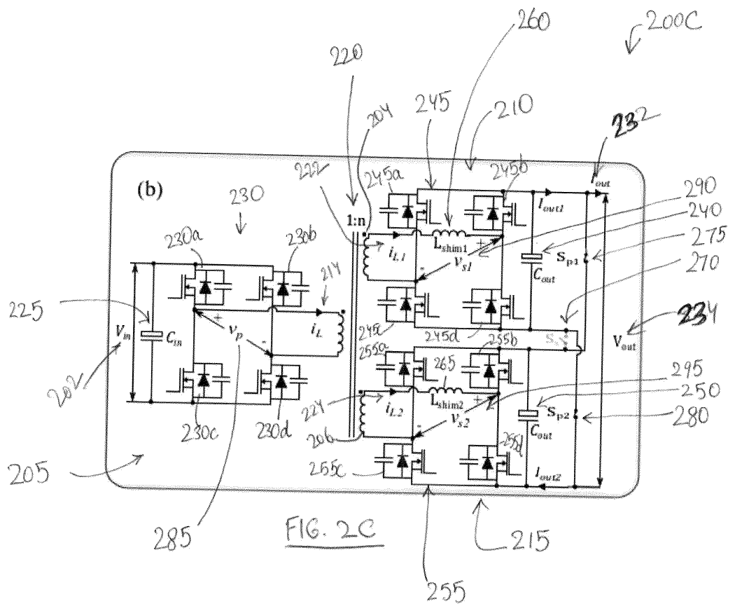

Reference is next made to FIG. 2A, which illustrates a schematic view of a dual-active bridge converter 200A, according to an example embodiment. The DAB converter 200A disclosed herein consists of a primary sub-circuit 205, a first secondary sub-circuit 210 and a second secondary sub-circuit 215.

As shown, the primary sub-circuit 205 and the secondary sub-circuits 210, 215 are coupled with each other using a transformer 220. The transformer 220, with dual secondary sub-units, is used to provide an isolation between the input and output bridges. In the illustrated embodiment, the two secondary windings 204, 206 have equal number of turns and share the same magnetic core. This provides the advantage of symmetric performance by the DAB converter 200A.

The DAB converter 200A shown herein operates at a fixed input DC-bus voltage, Vᵢₙ, 202. The primary sub-circuit 205 consists of an input capacitor 225, and four switches 230 including a first primary switch 230a, second primary switch 230b, third primary switch 230c and fourth primary switch 230d.

The first secondary sub-circuit 210 consists of a first output capacitor 240 and corresponding four switches 245, including a first secondary switch 245a, a second secondary switch 245b, a third secondary switch 245c and a fourth secondary switch 245d. The first secondary sub-circuit 210 also includes a first inductor, Lₛₕᵢₘ₁, 260.

The second secondary sub-circuit 215 consists of a second output capacitor 250 and four corresponding switches 255, including a first secondary switch 255a, a second secondary switch 255b, a third secondary switch 255c and a fourth secondary switch 255d. The second secondary sub-circuit 215 also includes a second inductor, Lₛₕᵢₘ₂, 265.

The input capacitor 225, and the first and second output capacitors 240, 250 are selected to avoid overheating of the capacitors. For example, in some cases, the capacitor bank is selected based on the converter analytical model and capacitor's datasheet rated ripple current. In other cases, the capacitor bank is selected, additionally or alternatively, to maintain an output voltage ripple below a predetermined threshold, such as, for example, below about 5%. In some cases, an identical capacitor is used on the primary and the secondary sides of the DAB converter 200A. In some other cases, the capacitor used on the primary side is differently rated than the capacitor used in the secondary side. In one example, the capacitor is an electrolytic capacitor with a capacitance of 150 μF/450 V. In another example, the capacitor is an electrolytic capacitor with a capacitance of 300 μF/900 V. In some embodiments, small film capacitors are added to the capacitor bank for decoupling to suppress higher frequency voltage ripples. In one example, three small film capacitors with capacitance of 0.1, 0.1, 0.47 μF, respectively, are used.

In some cases, the primary switches 230 are identical to the secondary switches 245, 255 in the secondary sub-circuits. In some other cases, the primary switches 230 are different than the secondary switches 245, 255 used in the secondary sub-circuits. As illustrated, the primary 230 and the secondary switches 245, 255 used in the DAB converter 200A are MOSFETs. In one example, the primary 230 and the secondary switches 245, 255 are selected to be the IMZ120R045M1 CoolSiC MOSFET from Infineon.

As illustrated in FIG. 2A, the primary sub-circuit 205 has a corresponding primary winding voltage, vₚ, 285, and a primary current, i_{L}, 214. Similarly, the first secondary sub-circuit 210 has a corresponding first secondary winding voltage, vₛ₁, 290, and a first secondary current, i_{L1}, 222, and the second secondary sub-circuit 215 has a corresponding second secondary winding voltage, vₛ₂, 295, and a second secondary current, i_{L2}, 224.

The first and the second secondary sub-circuits 210, 215 also include have a corresponding output current, Iₒᵤₜ₁ 232 and output voltage, Vₒᵤₜ, 234, which are also referred to as ‘output charging current’ and ‘output charging voltage’, respectively.

In some cases, the first inductor, Lₛₕᵢₘ₁, 260 used in the first secondary sub-circuit 210 and the second inductor, Lₛₕᵢₘ₂, 265 used in the second secondary sub-circuit 215 are added externally in the form of a shim inductor, as shown in the various embodiments herein. In some other cases, the first inductor 260 and the second inductor 265 can be integrated into the transformer leakage inductance of the transformer 220. In some further cases, the first inductor 260 and the second inductor 265 can be integrated as a combination of both shim inductors and integration with the transformer.

In various cases, the first inductor 260 and the second inductor 265 provide the advantage of mitigating high transient current flow between the primary and secondary winding voltages vₚ, vₛ₁, vₛ₂. This provides the advantage of smooth, effective power transfer between all three voltage sources. In various embodiments, the first shim inductor 260 and the second shim inductor 265 have equal inductance to achieve symmetric performance of the DAB converter 200A. This provides the advantage of maximum device utilization.

The DAB converter 200A has two operating modes, which is a combination of an input-parallel output-series (IPOSS) and an input-parallel output-parallel (IPOP) converter. The DAB converter 200A can be used for voltage sharing in high-voltage applications (IPOSs) or current sharing in high-power applications (IPOP).

To facilitate the transition between the two operating modes, the DAB converter 200A comprises a first transition switch 270, a second transition switch 275 and a third transition switch 280. The first, second and third transition switches 270, 275, 280 are bidirectional switches. In some cases, the first, second and third transition switches 270, 275, 280 are relays. In some other cases, the first, second and third transition switches 270, 275, 280 are any low frequency, bidirectional switches. In some embodiments, the first, second and third transition switches 270, 275, 280 are contactors. In addition to facilitating switching of the DAB converter 200A between the two modes of operation, the contactors may also provide the benefit of protecting and isolating the secondary sub-circuits 210, 215 for safe operation.

FIG. 2B illustrates the schematic view of the dual-active bridge converter 200A in the series output mode (S-mode) 200B. FIG. 2C illustrates the schematic view of the dual-active bridge converter 200A in the parallel output mode (P-mode) 2000. S-mode topology 200B can be used for high-voltage applications, and P-mode topology 2000 can be used for high-power applications.

As illustrated in FIG. 2B, in the S-mode operation, the first and the second secondary sub-circuits 210, 215 are connected in series. This provides the advantage of high output voltage (Vₒᵤₜ) 234. In the S-mode operation, the output current of each secondary sub-circuit 210, 215, Iₒᵤₜ₁ and Iₒᵤₜ₂ are equal to each other, which is equal to overall output current Iₒᵤₜ 232, i.e. Iₒᵤₜ₁=Iₒᵤₜ₂=Iₒᵤₜ. In the S-mode, equal current sharing can be achieved. For the DAB 200A to transition to S-mode of operation, the first transition switch 270 is closed, and the second and third transition switches 275, 280 are open.

As illustrated in FIG. 2C, in the P-mode operation, the first and the second secondary sub-circuits 210,215 are connected in parallel. This results in lower output voltage (Vₒᵤₜ) 234. In this mode of operation, the voltage amplitudes of the first and the second secondary winding, i.e. Vₛ₁ 290 and Vₛ₂ 295 are equal to each out, which is equal to output voltage, Vₒᵤₜ, 234. For the DAB 200A to transition to P-mode of operation, the first transition switch 270 is open, and the second and third transition switches 275, 280 are closed.

In the described embodiment, the transition output voltage (V_{T}) between the two modes of operation can be load dependent to maximize the efficiency in some cases, or can be fixed for simpler operation in other cases.

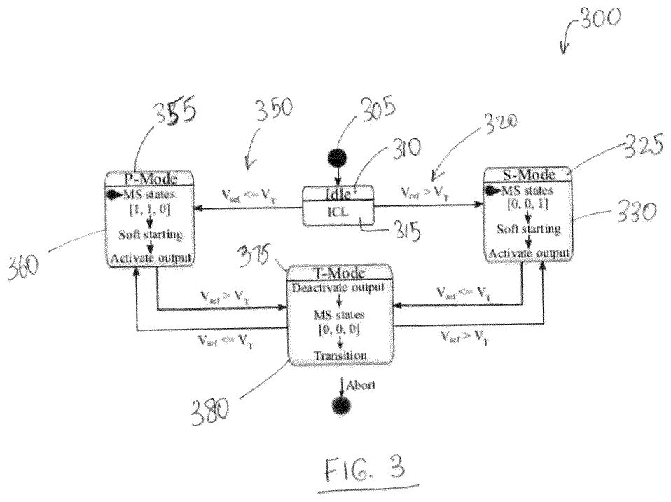

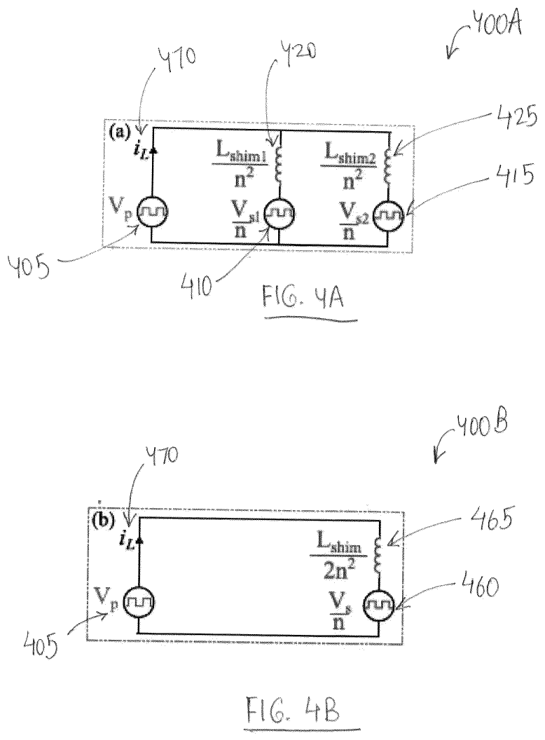

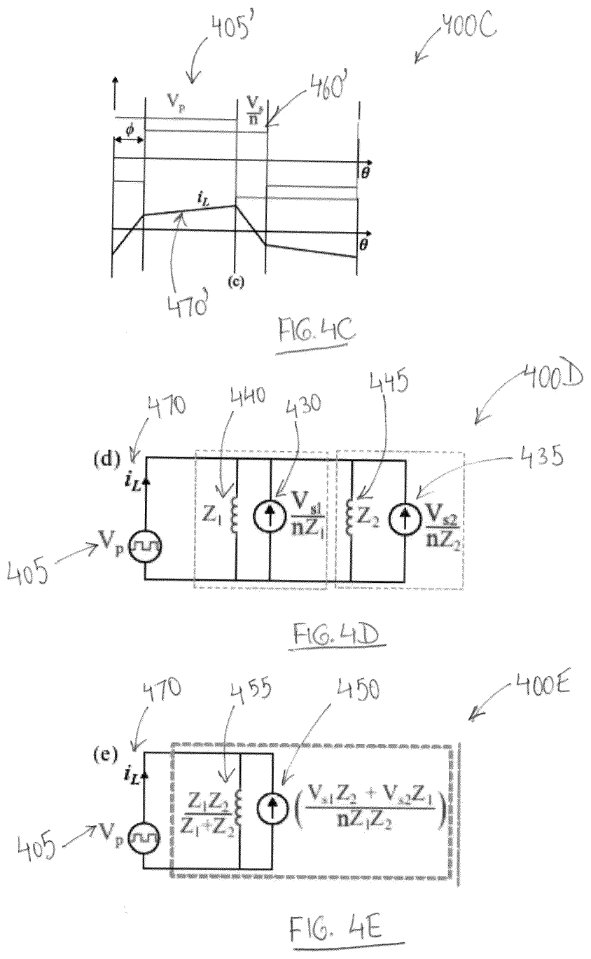

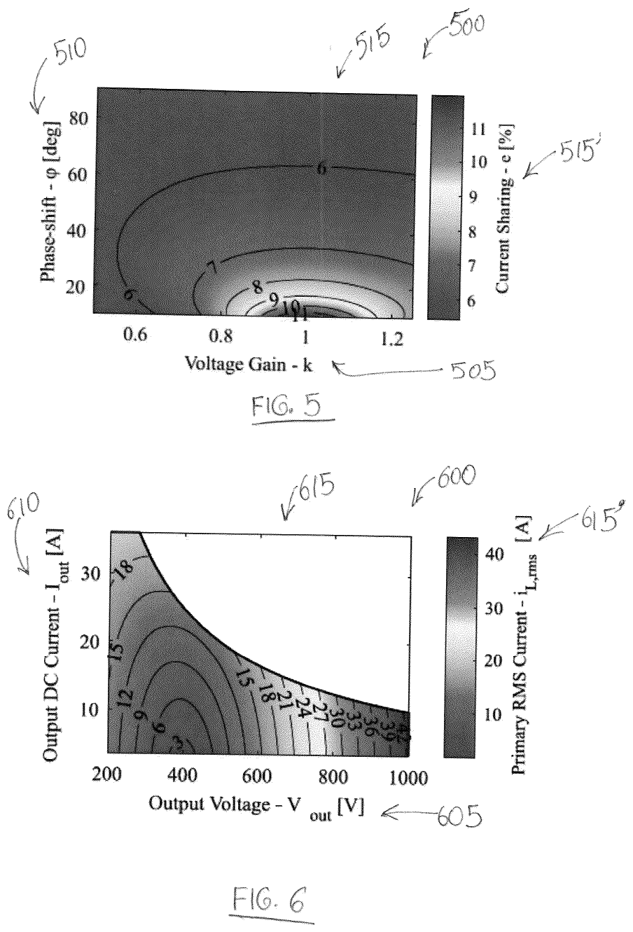

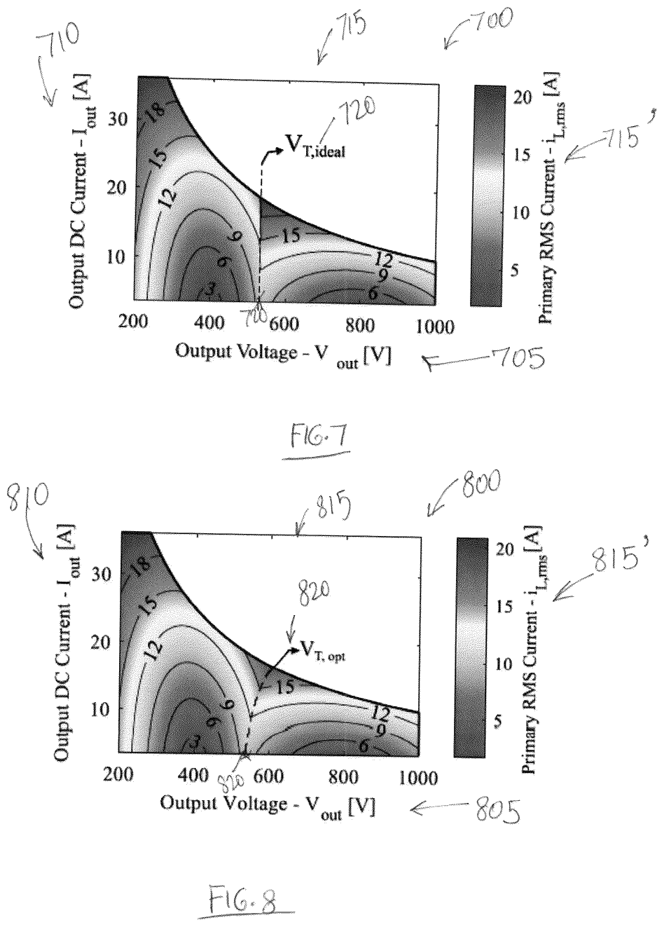

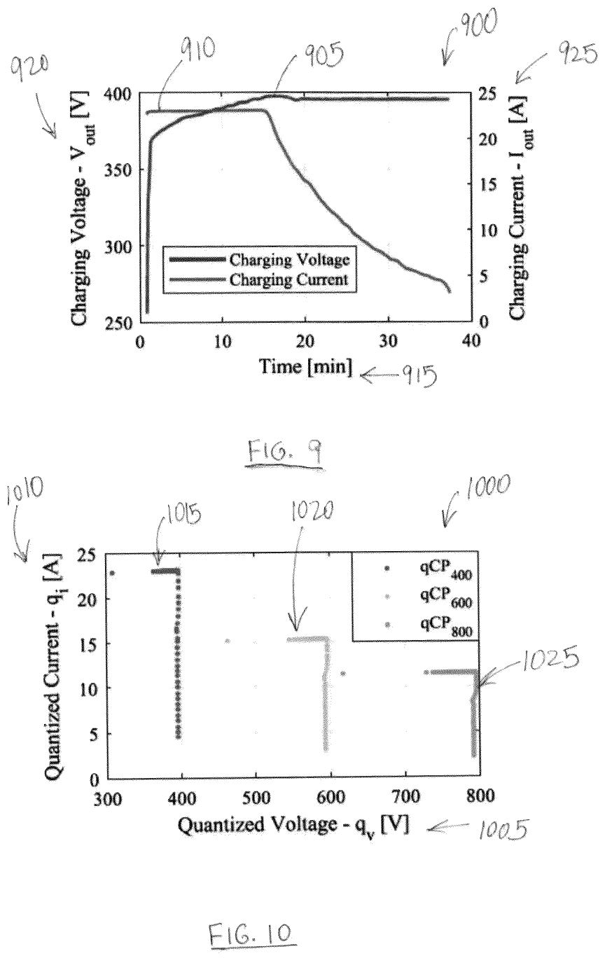

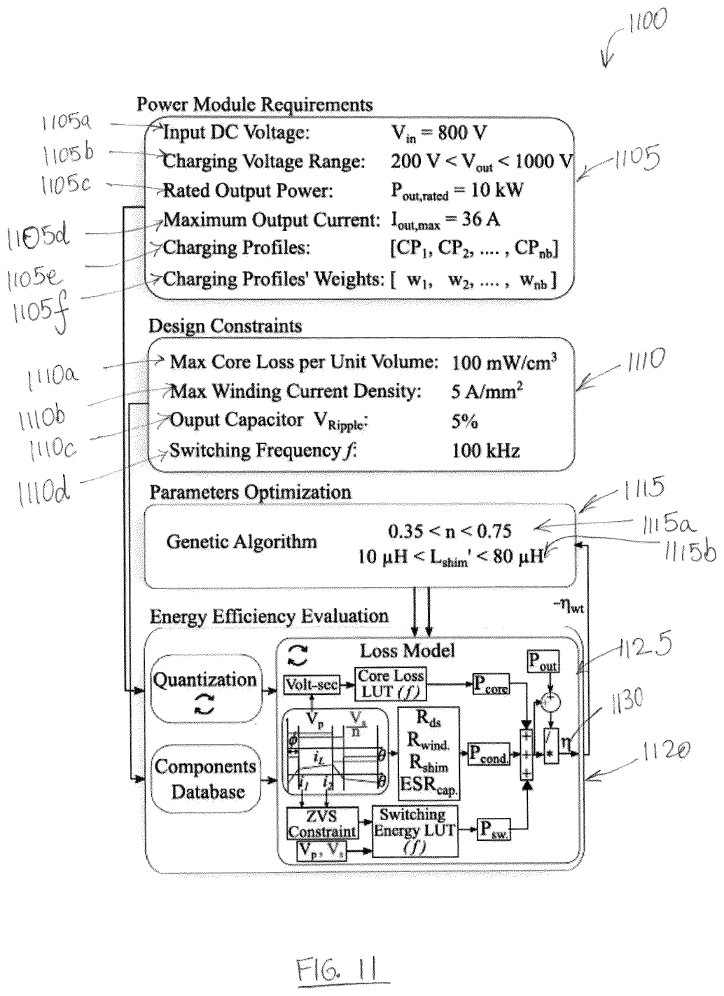

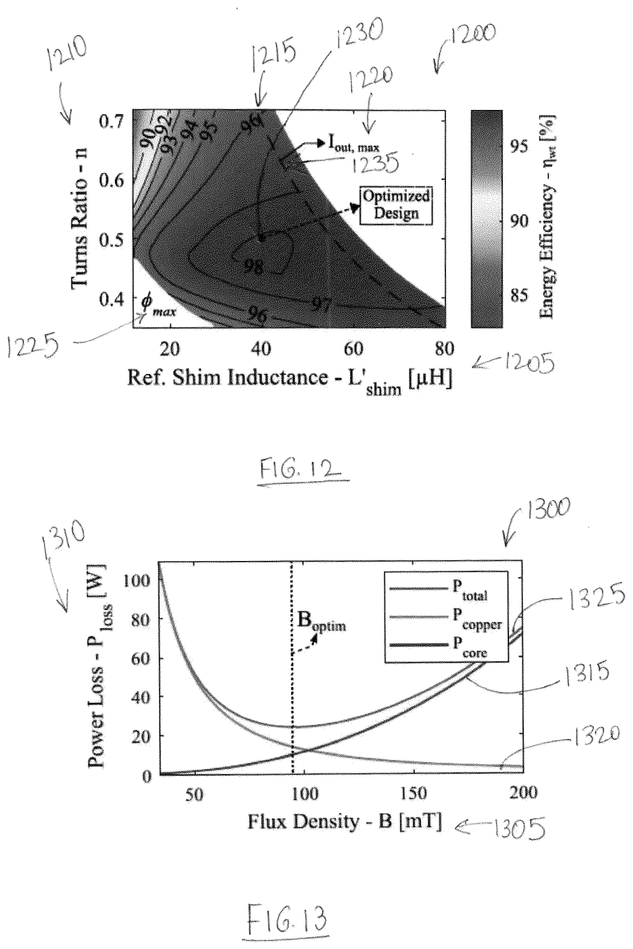

Reference is next made to FIG. 3, which illustrates a state machine view 300 of the transition between the operating modes of a DAB converter, such as DAB converter 200A of FIG. 2A. When a charging session of an electric vehicle is started, the DAB converter powers on at 305 and goes into an idle state 310. In the idle state 310, the inrush current limited (ICL) 315 is enabled and charges the primary side capacitor bank, such as capacitor bank 225 of FIG. 2A, and then waits for the charging command.

As illustrated in FIG. 3, if the requested charging voltage (V_{ref}) is higher than the transition voltage (V_{T}) at step 320, the S-mode 325 is triggered. In the S-mode, the series connection is made by setting 330 the mode switches (MS) states to [0, 0, 1], which corresponds to the switching states of [Sₚ₁, Sₚ₂, Sₛ], i.e. [second transition switch 275, third transition switch 280, first transition switch 270 of FIGS. 2A-2C].

If the requested charging voltage (V_{ref}) is lower than or equal to the transition voltage (V_{T}) at step 350, the P-mode 355 is triggered. In the P-mode, the parallel connection is made by setting 360 the mode switches (MS) states to [1, 1, 0], which corresponds to the switching states of [Sₚ₁, Sₚ₂, Sₛ], i.e. [second transition switch 275, third transition switch 280, first transition switch 270 of FIGS. 2A-2C].

In some embodiments disclosed herein, a fast-charging pole, such as a charging pole 130 of FIG. 1, is composed of multiple modules, such as a DAB converter 135 of FIG. 1, connected in parallel. In such embodiments, the transitioning between the operating modes for each module can be done in a series fashion. Hence, at any instant, there will be power delivered to the electric vehicle.

In the illustrated embodiment of FIG. 3, the transition mode (T-mode) 375 is an intermediate mode before reaching the target operation mode. T-mode is only triggered if a transition is required during an on-going charging session. In the T-mode, the mode switches states are set 380 to [0, 0, 0], which corresponds to the switching states of [Sₚ₁, Sₚ₂, Sₛ], i.e. [second transition switch 275, third transition switch 280, first transition switch 270 of FIGS. 2A-2C].

Reference is next made to FIG. 4A, which illustrates a schematic view 400A of a DAB converter according to an example embodiment. Schematic view 400A illustrates a three-voltage source model of the DAB converter disclosed in various embodiments herein. As illustrated in FIG. 4A, the three-voltage source model of the DAB converter 400A includes three active voltage sources which correspond to bridge voltages shown in FIGS. 2A-2C, i.e. the primary winding voltage Vₚ 285, the first secondary winding voltage Vₛ₁ 290 and the second secondary winding voltage Vₛ₂ 295.

As illustrated in FIG. 4A, the three-voltage source model of the DAB converter 400A can be represented as a parallel arrangement of the first active voltage source Vₚ 405 to a series combination of a first inductor, Lₛₕᵢₘ₁/n², 420 and the second active voltage source Vₛ₁/n 410, and to a series combination of a second inductor, Lₛₕᵢₘ₂/n², 425 and the third active voltage source Vₛ₂/n 415.

The difference between the S-mode and the P-mode, as discussed at least in FIGS. 2A-2C, is the ratio between the output charging voltage Vₒᵤₜ and the amplitude of the secondary winding voltage (Vₛ₁, Vₛ₂). This ratio, known as the conversion ratio, is defined in equation (1), where Vₛ is the voltage amplitude of the secondary winding:

$$M = \frac{{V}_{o u t}}{{V}_{s}} \qquad ( 1 )$$

The conversion ratio, M, depends on the converter operating mode. For a balanced operation in the S-mode, M is 2, while for the P-mode, M is 1. For a conventional DAB, M is constant and has a value of 1.

FIG. 4B illustrates a schematic view 400B of a two-voltage source equivalent current model 400B of the DAB converter disclosed herein. The schematic of FIG. 4B is derived based on the source transformation models of FIGS. 4D and 4E. FIG. 4D is a schematic view 400D of a voltage source to current source equivalent circuit model of the DAB converter 400A of FIG. 4A according to an example embodiment. FIG. 4E is a schematic view 400E of a single current and voltage source equivalent model of the DAB converter 400D of FIG. 4D according to an example embodiment.

The illustrated model of FIG. 4B is derived by replacing each secondary voltage source 410, 415 and corresponding series impedance 420, 425 of FIG. 4A with an equivalent current source 430, 435 and parallel impedance 440, 445. In particular, the series combination of second active voltage source 410 and the first inductor 420 is replaced with the equivalent parallel combination of a first current source, Vₛ₁/(nZ₁), 430 and first impedance, Z₁, 440. The series combination of third active voltage source 415 and the second inductor 425 is replaced with the equivalent parallel combination of a second current source, Vₛ₁/(nZ₁), 435 and second impedance, Z₁, 445.

Next, as illustrated in FIG. 4E, the two-current sources and parallel impedance of FIG. 4D are combined into an equivalent current source 450 and parallel impedance 455.

Next, a second source transformation for the model illustrated in FIG. 4E is carried out to yield the equivalent two-voltage source model of FIG. 4B. To ensure design symmetry between the two secondary sub-circuits 210, 215, the voltages Vₛ₁=Vₛ₂=Vₛ and impedance Z₁=Z₂=Z. The illustrated model 400B of FIG. 4B includes a first active voltage source, Vₚ, 405 in parallel with a series combination of a second active voltage source, Vₛ/n, 460 and an inductor, Lₛₕᵢₘ/2n², 465.

Reference is next made to FIG. 4C, which illustrates a graphical representation of waveforms 405′, 460′, 470′ respectively representing the first active voltage source, Vₚ, 405, the second active voltage source, Vₛ/n, 460, and the primary current i_{L}, 470 of FIG. 4B.

By performing a steady-state Fourier analysis for the key waveforms 405′, 460′ and 470′ in FIG. 4C, the DAB converter key formulae are derived based on equations (2) (15) below. In the illustrated embodiment, the Fourier analysis is based on single-phase shift (SPS) modulation. Other modulation techniques, such as, for example, triple-phase shift (TPS) may be used as well.

$${v}_{p , i} = \frac{4 {V}_{i n}}{i π} sin ( i θ ) , {v}_{p} = {\sum }_{i = 1 , 3 , 5 , ...}^{∞} {v}_{p , i} \qquad ( 2 )$$

$${v}_{s , i} = \frac{4 {V}_{out}}{i π M} sin ( i ( θ - ϕ ) ) , {v}_{s} = {\sum }_{i = 1 , 3 , 5 , ...}^{∞} {v}_{s , i} \qquad ( 3 )$$

$${i}_{L} = {Σ}_{i = 1 , 3 , 5 , ...}^{∞} \frac{{v}_{p , i} - \frac{{v}_{s , i}}{n}}{π if ( \frac{{L}_{s h i m}}{{n}^{2}} ) j} \qquad ( 4 )$$

In equations (2)-(4), vₚ is the primary winding voltage, i is the harmonic order, and vₛ is the secondary winding voltage. θ is the instantaneous angle, and n is the secondary to primary transformer turns ratio. ϕ is the phase shift angle between vₚ and vₛ, where −π/2<ϕ<π/2. f is the switching frequency, and j is the imaginary component.

Using the formulae (2), (3) and (4), formulae for the real output power Pₒᵤₜ, the output charging current Iₒᵤₜ, and the primary winding RMS current i_{L,rms} are derived as shown in equations (5)-(7):

$${P}_{o u t} = {\sum }_{i = 1 , 3 , 5 , ...}^{∞} \frac{8 {nV}_{in} {V}_{o u t} sin ( i ϕ )}{{M ( i π )}^{3} f {L}_{shim}} , {I}_{o u t} = \frac{{P}_{o u t}}{{V}_{o u t}} \qquad ( 5 )$$

$${i}_{L , rms} = \frac{2 \sqrt{2} {n}^{2}}{{π}^{2} f {L}_{s h i m}} \times \sqrt{{\sum }_{i = 1 , 3 , 5 , ...}^{∞} \frac{1}{{i}^{4}} ( {( \frac{{V}_{o u t}}{M n} )}^{2} + {V}_{i n}^{2} - 2 \frac{{V}_{i n} {V}_{o u t} cos ( i ϕ )}{M n} )} \qquad ( 6 )$$

$$k = \frac{{V}_{out}}{{nV}_{in} M} \qquad ( 7 )$$

To analyze power sharing between the two secondary sub-circuits 210, 215, AC-equivalent circuit analysis is performed for the model illustrated in FIG. 4A. The impedance of each secondary winding path can be mainly evaluated from the shim inductors impedance (Z₁, Z₂) at the fundamental frequency. A+2.5% impedance tolerance is assigned to Z₁, and a −2.5% tolerance is assigned to Z₂. In various embodiments, Z, and Z₂ represents the loop impedance mismatch of the two secondary windings. Additionally or alternatively, duty cycle mismatch between the two secondary bridges also affects the power sharing between the two secondary sub-circuits 210, 215. The maximum duty cycle mismatch is attributed by the maximum pulse-width distortion (ϕ_{pwd}) of the used gate driver. The current sharing error (e) between the two secondary currents (i_{L1}, i_{L2}) in the P-mode can be evaluated using formulae (6), (8) and (9):

$$e = \frac{\vert {i}_{L 1} \vert - \vert {i}_{L 2} \vert}{\vert {i}_{L 1} \vert + \vert {i}_{L 2} \vert} 200 \qquad ( 8 )$$

$$\frac{\vert {i}_{L 1} \vert}{\vert {i}_{L 2} \vert} = \frac{{z}_{2}}{{z}_{1}} \sqrt{\frac{{k}^{2} - 2 k cos ( ϕ ) + 1}{{k}^{2} - 2 k cos ( ϕ + {ϕ}_{p w d} ) + 1}} \qquad ( 9 )$$

Reference is briefly made to FIG. 5, which illustrates a graphical representation 500 of a current sharing error of a DAB converter according to an example embodiment. The graphical representation 500 shows the current sharing error (e) between the two secondary windings in the P-mode (i.e. between two secondary currents i_{L1}, i_{L2}) with a 5% impedance mismatch and maximum pulse-width distortion (ϕ_{pwd}) of 0.72°. As shown, the x-axis represents the voltage gain, k, 505, and the y-axis represents the phase-shift angle (ϕ) between vₚ and vₛ 510. Plot 515 illustrates the current sharing error. As shown, plot 515 illustrates that even with a 5% impedance mismatch and maximum pulse-width distortion (ϕ_{pwd}), the error 515′ is kept below ˜11% across the operating region, especially at higher power. This indicates that for simplification, it can be assumed that a symmetrically designed DAB converter, as disclosed herein, has equal current sharing for the two secondary sub-units 210, 215.

The output transition voltage (V_{T}) between the modes can be evaluated by assuming operation at low output current Iₒᵤₜ₁ to ensure an ideally linear relationship between the primary RMS current and the voltage gain k. As such, the ideal transition occurs when the gain k at one mode is closer to unity gain than the other mode. The condition for transitioning to the S-mode is given in equation (10), where kₛ and kₚ are the actual gains in the S-mode and P-mode, respectively:

$$1 - {k}_{s} < {k}_{P} - 1 \qquad ( 10 )$$

Using equations (1), (7) and (10), a simple equation (11) is derived for evaluating the ideal transition voltage V_{T,ideal}:

$${V}_{T , ideal} = \frac{4}{3} n {V}_{in} \qquad ( 11 )$$

Reference is next made to FIG. 6, which illustrates a graphical representation of an RMS current map 600 for a conventional 10 kW DAB with a target peak performance at output charging voltage, Vₒᵤₜ=400V (unity gain). In the illustrated embodiment, the RMS current map 600 is plotted using equations (5) and (6). As shown, the x-axis represents the output voltage, Vₒᵤₜ, 605, and the y-axis represents the output DC current (Iₒᵤₜ) 610. Plot 615 illustrates the primary RMS current, i_{L,rms}. As shown in plot 615, significantly large reactive currents 615′ occur at points away from the unity gain point. This leads to extremely high current and voltage stress per device, which results in higher system cost and reduced performance.

Reference is next made to FIG. 7, which illustrates a graphical representation of an RMS current map 700 for the proposed DAB converter according to an example embodiment. In the illustrated embodiment, a 10 kW DAB under a fixed, ideal transition voltage (V_{T,ideal}) is used. The parameter values of n, Lₛₕᵢₘ and f for the DAB converter illustrated in FIGS. 6 and 7 are equivalent for a true comparison. As shown in FIG. 7, the x-axis represents the output voltage, Vₒᵤₜ, 705, and the y-axis represents the output DC current (Iₒᵤₜ) 710. The fixed ideal transition voltage V_{T,ideal} is shown at point 720. Plot 715 illustrate the primary RMS current, i_{L,rms}. As seen in plot 715, drastically lower RMS current 715′ is seen over the entire voltage range Vₒᵤₜ in contrast to the results of FIG. 6. This indicates lower voltage stress per device, indicating a higher device utilization for the same required output power and 200-1000V voltage range. As illustrated, the DAB converter of FIG. 7 can efficiently cater to both 400V and 800V output charging voltage demands of EVs.

Reference is next made to FIG. 8, which illustrates a graphical representation of an RMS current map 800 for the proposed DAB converter according to another example embodiment. In the illustrated embodiment, a 10 kW DAB under an optimal transition voltage is used. The optimal transition voltage (V_{T,opt}) can be determined for a given converter parameters and operating conditions using equations (12) and (13):

$$\frac{3}{4} \frac{{v}_{T , opt}^{2}}{n} - {V}_{in} {V}_{T , opt} ( 2 cos ( {ϕ}_{P} ) - cos ( {ϕ}_{S} ) ) = 0 \qquad ( 12 )$$

$${ϕ}_{m} = \frac{π}{2} ( 1 - \sqrt{1 - ( \frac{4 {MI}_{o u t} f {L}_{shim}}{n {V}_{in}} )} ) \qquad ( 13 )$$

Equation (12) is derived by having i_{L,rms} (M=1, ϕ_{P})=I_{L,rms} (M=1, ϕ_{S}) using equation (6). The required unknowns for this formula are the phase shift angles ϕ_{P} and ϕs for each operating mode, and the optimal transition output voltage V_{T,opt}. An expression for ϕₚ can be evaluated from (13) by setting M to 1. Similarly, ϕs is evaluated by setting M to 2.

The parameter values of n, Lₛₕᵢₘ and f for the DAB converter illustrated in FIGS. 6, 7 and 8 are equivalent for a true comparison. As shown in FIG. 8, the x-axis represents the output voltage, Vₒᵤₜ, 805, and the y-axis represents the output DC current (Iₒᵤₜ) 810. Reference 820 illustrates the optimal transition voltage V_{T,opt}.

Plot 815 illustrates the primary RMS current, I_{L,rms}. As seen in plot 815, drastically lower RMS current 815′ is seen over the entire voltage range Vₒᵤₜ in contrast to the results of FIG. 6. This indicates a lower voltage stress per device, indicating a higher device utilization for the same required output power and 200-1000V voltage range.

Further, as illustrated, an optimal transition voltage V_{T,opt}, in contrast to a fixed transition voltage V_{T,ideal} shown in FIG. 7, can be used to minimize the RMS current 815′ during a transition. Similar to FIG. 7, the DAB converter of FIG. 8 can also efficiently cater to both 400V and 800V output charging voltage demands of EVs.

In some embodiments, other modulation techniques, such as, for example, triple-phase shift (TPS), can be incorporated to reduce the circulating RMS current further to lower point operation. Application of TPS to the DAB converter disclosed herein to illustrate the possible efficiency improvement is discussed below.

In various embodiments, equations (14) and (15) can be used to determine the maximum RMS current and peak voltage of various devices used in a DAB converter. These provide the advantage of sizing and determining the required devices' kVA rating:

$${I}_{s w - p r i} = \frac{{i}_{L , rms - max}}{\sqrt{2}} , {I}_{s w - s e c} = \frac{{I}_{s w - p r i}}{n {N}_{s e c}} \qquad ( 14 )$$

$${V}_{s w - pri , peak} = {V}_{p , max} , {V}_{s w - sec , peak} = {V}_{s , max} \qquad ( 15 )$$

N_{sec} in (14) denotes the number of secondary winding.

In various embodiments, the kVA ratings for the considered devices (switches, diodes, flying capacitors, and transformer, etc.) are added to obtain the total kVA rating of the DAB converter.

In some embodiments, the kVA ratings of various devices in the DAB converter can be determined by assuming an ideally balanced system, and assuming that the device's peak voltage is half the transformer winding voltage, V_{p,max}/2, and V_{s,max}/2 for the primary and secondary devices, respectively. Using this assumption, combined with equations (14), (15), the kVA ratings of various devices can be determined.

The DAB converter disclosed herein is compared to the conventional DAB and a conventional neutral point diode clamped dual-active bridge (NPC-DAB) in Table II below:

TABLE II
Table II
CONVERTERS COMPARISON

| | | | Flying | Transformer | Total | |
|---|---|---|---|---|---|---|
| | Switches | Diodes | Capacitors | kVA | kVA | |
| | Quantity | Quantity | Quantity | Rating | Rating | |
| Converter Type | **(pri/sec) | **(pri/sec) | **(pri/sec) | [p.u] | [p.u] | Complexity |
| Conventional DAB | 4/4 | 0/0 | 0/0 | 2 | 2.7 | Low |
| *NPC DAB in [13] | 8/8 | 4/4 | 2/2 | 0.9 | 2.6 | High |
| Proposed DAB | 4/8 | 0/0 | 0/0 | 1 | 1 | Medium |

*Scaled up to 10 kW.
**pri denotes the primary side bridge, similarly sec denotes the secondary bridge.

To compare the three converters seen in Table II against each other, the total kVA is normalized relative to the proposed DAB converter rating. As shown in table II, the DAB converter disclosed herein has significant overall advantages in device count, utilization, and cost-effectiveness, while still maintaining moderate system complexity, in terms of needed control strategies and component count.

In the various embodiments illustrated herein, the DAB converter needs to maintain high performance for a broad range of operating points. However, the conventional converter design method mainly considers operation at the rated point, leading to a locally optimized solution instead of a global one, which causes reduced performance and a lack of insight into the charger behavior during actual charging scenarios.

Instead of relying only on the power efficiency value at a rated point, an energy efficiency-based DAB converter design and manufacturing method is discussed herein.

The method ensures a full range of charging scenarios by assigning weights to the operational points based on the amount of energy spent during each point. Additional weights (W_{nb}) can be defined based on the application requirements, where nb is the charging profile index, which gives priority to certain charging profiles (CP_{nb}) over others in the DAB converter design and manufacturing process. An advantage of this methodology is that it is beneficial in fleet charging applications, where specific charging profiles are dominant.

The methodology, as discussed in further detail with reference to FIG. 11, consists of i) quantization of charging profiles into energy pairs; ii) determining the DAB converter's power requirements and design constraints; iii) determining the initial DAB converter parameters, i.e. the transformer turns ratio, n, and reflected shim inductance on the primary side L′ₛₕᵢₘ; iv) optimizing the DAB converter parameters using genetic algorithm (GA); and v) designing the dual-secondary transformer and, accordingly, the DAB converter. In some cases, the determining of the DAB converter's power requirements and design constraints, and determining the initial DAB converter parameters, i.e. the transformer turns ratio, n, and reflected shim inductance on the primary side L′ₛₕᵢₘ are carried out before the quantization of charging profiles into energy pairs. In such embodiments, the quantization step may be carried out during the GA optimization process.

Reference is briefly made to FIG. 9, which illustrates a graphical representation 900 of a charging profile of a DAB converter disclosed herein. In the illustrated embodiment, the DAB converter has a 10 kW, 400V charging profile (CP₄₀₀) scaled down from the 50 kW, 400V charging profile belonging to the Nissan Leaf 2015. As shown, plot 905 represents the change in charging voltage Vₒᵤₜ 920 over time 915. Plot 910 represents the change in charging current Iₒᵤₜ 925 over time 915. Although the charging profile CP₄₀₀ is illustrated in FIG. 9, similar profiles can be generated for higher charging profiles, such as, for example, CP₆₀₀ and CP₆₀₀ for a 600V and 800V system respectively.

Reference is next made to FIG. 10, which illustrates a graphical representation 1000 of quantized energy profiles of charging profiles CP₄₀₀, CP₆₀₀ and CP₈₀₀ for a 400V, 600V and 800V system, respectively. The x-axis represents the quantized voltage, qᵥ, 1005, and the y-axis represents the quantized current, qᵢ, 1010. Plot 1015 represents the quantized representation of charging profile CP₄₀₀, plot 1020 represents the quantized representation of charging profile CP₆₀₀ and plot 1025 represents the quantized representation of charging profile CP₆₀₀. The quantized profiles 1015, 1020 and 1025 are generated to convert the charging profile voltage Vₒᵤₜ and current Iₒᵤₜ points, as shown in FIG. 9, to weighted energy points. Quantized voltage qᵥ in equation (16) and quantized current qᵢ in equation (17) hold the weighted average value for the changing voltage Vₒᵤₜ and current Iₒᵤₜ₁ respectively. The average is taken over an energy interval qⱼ, where each weighted energy point in FIG. 10 with a coordination (qᵥ, qᵢ) has an equal amount of charging energy qⱼ.

$${q}_{v} ( m ) = \frac{1}{{\int }_{q T ( m - 1 )}^{qT ( m )} {I}_{out} ( t ) dt} {\int }_{q T ( m - 1 )}^{qT ( m )} {V}_{o u t} ( t ) {I}_{o u t} ( t ) dt \qquad ( 16 )$$

$${q}_{i} ( m ) = \frac{1}{{\int }_{qT ( m - 1 )}^{qT ( m )} {V}_{out} ( t ) dt} {\int }_{qT ( m - 1 )}^{qT ( m )} {I}_{o u t} ( t ) {V}_{o u t} ( t ) dt \qquad ( 17 )$$

Jₜₒₜₐₗ in equal (18) is the total energy spent during the charging session:

$${J}_{total} = {\int }_{0}^{{t}_{max}} {V}_{o u t} ( t ) {I}_{out} ( t ) dt , {q}_{j} = \frac{{J}_{total}}{{N}_{q}} \qquad ( 18 )$$

In equation (18), t is the charging time instant, tₘₐₓ is the charging time duration, and N_{q} is the total number of quantized energy points for each profile. qT is an array with a size of m+1 which contain the charging time instants corresponding to energy increments of qⱼ as defined in equation (19), and J(t) is the accumulated energy up to a charging time t. m is the quantization index and should abide by equation (20).

$$qT ( m ) \{ \begin{matrix}t , & if J ( t ) - J ( qT ( m - 1 ) ) = {q}_{j} ∧ m > 1 \\ t , & else if J ( t ) = {q}_{j} ∧ m = 1 \\ qT ( m ) , & otherwise\end{matrix} \qquad ( 19 )$$

$$m ∈ \{ z ∈ \text{ℤ:1} \leq z \leq {N}_{q} \} \qquad ( 20 )$$

Reference is next made to FIG. 11, which illustrates the methodology 1100 for optimizing the DAB converter disclosed herein. Methodology 1100 begins at step 1105 where power module requirements 1105 are identified. The power module requirements may include one or more of the parameters such as, for example, input DC voltage 1105a, charging voltage range 1105b, rated output power 1105c, maximum output current 1105d, charging profiles [CP₁, CP₂, . . . , CP_{nb}] 1105e and charging profiles' weights [w₁, w₂, . . . , w_{nb}] 1105f.

In some embodiments, the input DC voltage 1105a is 800V, the charging voltage range 1105b extends between 200V and 1000V, the rated output power 1105c is 10 kW and the maximum output current 1105d is 36 A.

Next, at step 1110, the design constraints are identified. The design constraints are essential in determining the design boundaries and selecting the appropriate converter components. The design constraints identified at step 1110 may include one or more constraints such as, for example, maximum core loss per unit volume 1110a for the transformer core (e.g. transformer 220 of FIG. 2A), maximum winding current density 1110b of the transformer winding (e.g. transformer 220 of FIG. 2A), output capacitor V_{Ripple} 1110c and switching frequency f 1110d of the transformer winding (e.g. transformer 220 of FIG. 2A).

In various embodiments disclosed herein, the parameters of maximum current density 1110b and frequency 110d of the transformer windings are used to select the appropriate litz wire size and thread count for the transformer.

In various embodiments disclosed herein, the capacitor bank is selected to remain below the maximum output voltage ripple 1110c, and MOSFETs ratings (such as, for example, for primary and secondary switches 230, 245, 255 of FIG. 2A) are selected based on the maximum primary and secondary winding voltages, Vₚ, Vₛ, and primary current, i_{L}.

In some embodiments, the maximum core loss per unit volume 1110a is 100 mW/cm³, maximum winding current density 1110b is 5 A/mm², output capacitor V_{Ripple} 1110c is 5% and switching frequency f 1110d is 100 kHz.

Next, at step 1115, the initial DAB converter parameters, i.e. the transformer turns ratio, n, 1115a and reflected shim inductance on the primary side L'ₛₕᵢₘ 1115b are determined, followed by the optimization loop using genetic algorithm (GA). In various embodiments, the genetic function to be minimized is negative the DAB converter's total weighted energy efficiency (−η_{wt}) for the considered charging profiles, where η_{wt} is defined in equation (21) as follows:

$${η}_{wt} = \frac{1}{{N}_{q} {\sum }_{nb = 1}^{{N}_{b}} {W}_{n b}} {\sum }_{nb = 1}^{{N}_{b}} {\sum }_{nq = 1}^{{N}_{q}} η {W}_{n b} , η = \frac{100 {P}_{out}}{{P}_{out} + {P}_{loss}} \qquad ( 21 )$$

The charging profiles can be assigned equal weights or different weights depending on the application requirements. For example, in the embodiment illustrated in FIG. 10, the charging profiles are assigned equal weights W_{nb}. In such embodiments, for each quantized point (n_{q}), Pₒᵤₜ and Pₗₒₛₛ in equation (21) are the converter's output power and total power loss, respectively.

Referring back to step 1115, after quantizing the charging profiles into energy points and setting the converter maximum operational envelope in terms of current, voltage, and power, the design optimization loop begins next. The initial loop assumes a pair of n and L′ₛₕᵢₘ at the rated power point close to the mid-range of the converter voltage, and V_{T} is set to V_{T,ideal}. Next, the initial components are sized and selected for the converter loss modelling. During the optimization loop, the components selection can be updated based on the optimization variables n, L′ₛₕᵢₘ, 1115a, 1115b, set by the genetic algorithm.

At next step 1120, energy efficiency of DAB converter is evaluated based on the values of the optimized variables. Also shown in FIG. 11 is an overview of the simplified converter loss model 1125 according to an example embodiment. As shown, the converter power loss is based on the losses look-up table (LUT) for each component, which in some cases, may be determined based on the LUTs attained from the manufacturer, the soft-switching constraints and the analytical Fourier model discussed above in relation to FIGS. 4A-4E. Based on the given parameters and charging profiles, the efficiency 1130 can be calculated at each operating point. The optimization process is repeated for all operating points. This is illustrated in FIG. 12.

Reference to FIG. 12, illustrated therein is a weighted total energy efficiency map (η_{wt}) 1200 of the DAB converter with the transition voltage being the fixed, ideal transition voltage. As shown, the x-axis represents the shim inductance L′ₛₕᵢₘ 1205 and the y-axis represents the turns ratio n 1210 of the transformer core. Plot 1215 shows the energy efficiency map η_{wt} for the three charging profiles CP₄₀₀, CP₆₀₀ and CP₆₀₀ for a 400V, 600V and 800V system, under SPS and a fixed transition voltage. The upper optimization boundary I_{out,max} 1220 is set to ensure that the converter with the optimized parameters is able to produce the required maximum output charging current I_{out,max}. The n, L′ₛₕᵢₘ corresponding to the space ϕₘₐₓ 1225 is avoided to ensure that the considered quantized operating points are achievable well below the converter's maximum phase-shift angle of π/2. FIG. 12 also illustrates at 1230 that the optimized DAB converter is able to achieve an energy efficiency η_{wt} above 98% at the optimized parameter values of n=0.5 and L′ₛₕᵢₘ=40μH.

In various embodiments disclosed herein, the phase-shift range should be large enough for control resolution, however, not too large to avoid high circulating current. This can be satisfied by having ϕₘᵢₙ>C.θ_{dead}, where θ_{deadcan} be evaluated from the configured dead time. c is a factor above one, which depends on the targeted control resolution. ϕₘᵢₙ is the minimum phase-shift angle for the considered operating points.

In various embodiments disclosed herein, designing a transformer, such as the transformer 220 of FIGS. 2A-2C, requires determining the required core size and material, then optimizing the maximum flux-density (Bₘₐₓ) and winding configuration to minimize the transformer total losses.

In various embodiments, the required core material and area produce (Aₚ) are determined based on the DAB converter's maximum RMS current (i_{L,max}) as shown in equation (6), and design constraints (f, J, K_{U}, Bₘₐₓ). In one example, the ferrite core material 3C92 from ferrox-cube is selected based on the used switching (f) of 100 kHz.

In some embodiments, a typical volumetric core loss density (Pᵥ) of 100 mW/cm³ is assumed to determine the initial maximum flux-density (Bₘₐₓ) from the core material datasheet. In such embodiments, the minimum core area (Aₑ) is evaluated using equation (22), where Nₚ is the number of turns of the primary winding. The winding area (A_{w}) is also evaluated using equation (22). The utilization factor Kᵤ is set to 0.25 to account for insulation, clearances, and imperfect winding arrangement. The current density J is set to a typical value of 5 A/mm². Aₚ is evaluated using (22) by multiplying Aₑ and A_{w}. Then, a core with an area product A_{p,core}>Aₚ can be selected.

$${A}_{e} = \frac{{V}_{p , max}}{2 {N}_{p} f {B}_{max}} , {A}_{w} = \frac{2 {N}_{p} {i}_{L , max}}{{JK}_{u}} \qquad ( 22 )$$

In various embodiments, the maximum flux density (Bₘₐₓ), and the number of turns are optimized to minimize the transformer total losses and ensure operation away from saturation for a given candidate core. The core stack is selected based on the calculated Aₚ discussed above. In some embodiments, the transformer core is composed of 2 sets of E71/33/32 cores.

In various embodiments, the core loss (P_{core}) is evaluated from the core loss look-up table (LUT), such as, for example, in the core manufacturer datasheet. The copper loss (P_{CU}) is calculated based on the primary max RMS current i_{L},max and the winding resistance. The transformer core and copper loss can be calculated using equation (23). The total power loss (Pₜₒₜₐₗ) can be calculated by adding the terms in equation (23). This is illustrated in the plot 1300 shown in FIG. 13.

$${P}_{core} = L U T ( core , {B}_{max} , f ) , {P}_{c u} = \frac{ρ {V}_{p , max}^{2} {i}_{L , max}^{2}}{{f}^{2} {B}_{max}^{2} {A}_{e}^{2} {A}_{w} {K}_{u}} \qquad ( 23 )$$

FIG. 13 illustrates a graphical representation 1300 of transformer optimal flux density (Bₒₚₜᵢₘ) selection. The x-axis represents the flux density, B, 1305. The y-axis represents the power loss Pₗₒₛₛ 1310. Plot 1315 illustrates the transformer core loss P_{core}, plot 1320 illustrates the transformer copper loss P_{copper} and plot 1325 illustrates the total transformer power loss Pₜₒₜₐₗ, which is a combination of P_{core} and P_{copper}.

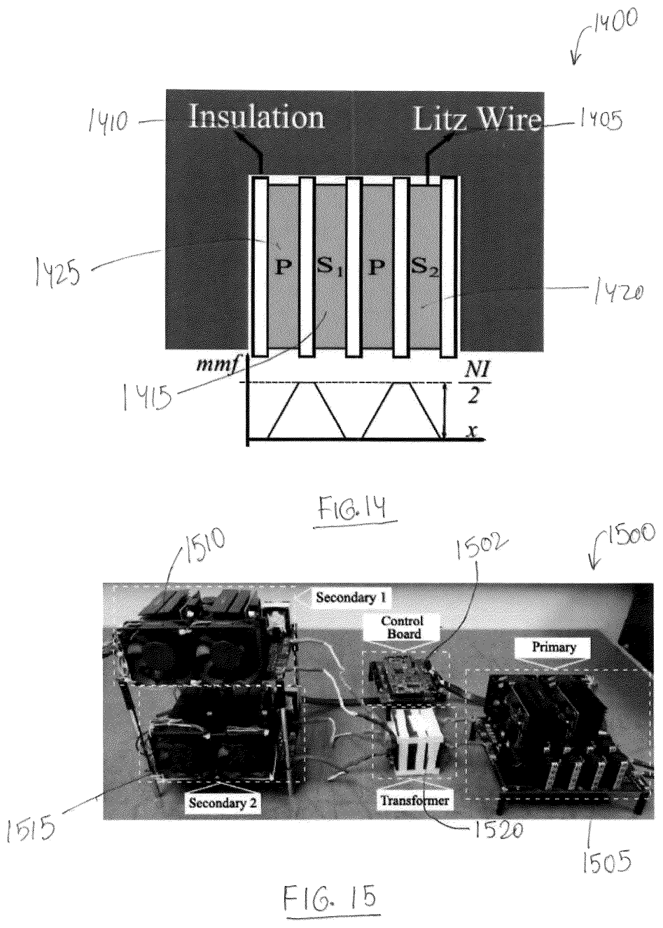

Reference is next made to FIG. 14, which illustrates a dual-secondary transformer winding configuration 1400 of a DAB converter according to an example embodiment. The illustrated embodiment shows a fully interleaved structure at the set design constraints by using a 170/40 AWG Litz wire 1405 and two interleaving layers 1410.

Shown in the illustrated embodiment is the primary winding layer P, 1425, and two isolated secondary winding layers S₁ 1415 and S₂ 1420. In one example, each primary wire has two parallel wound Litz wires, each with 12 number of turns. In another example, each secondary wire is composed of 4 parallel would Litz wires, each with 6 number of turns. In some other examples, the transformer includes a combination of these primary and secondary winding configurations.

Reference is next made to FIG. 15, which illustrates an experimental setup 1500 of a prototype of the DAB converter disclosed herein, according to an example embodiment. As shown, the experimental setup 1500 of the DAB converter includes a primary sub-circuit 1505, a first secondary sub-circuit 1510 and a second secondary sub-circuit 1515. The transformer 1520 isolates the primary and the secondary sides. The controller 1502 is configured to control the operation of the DAB converter.

In the illustrated embodiment, the DAB converter is a 10 kW silicon-carbide based converter. The specifications for the DAB converter shown herein consists of an input voltage Vᵢₙ of 800V, an output voltage range Vₒᵤₜ of 200V-1000V, a rated power P_{out,rated} of 10 kW, a maximum output DC current I_{out,max} of 36A, a maximum RMS current i_{L,max} of 21A, a switching frequency f of 100 kHz, a shim inductance Lₛₕᵢₘ of 20 pH, a number of turns ratio of 12:6:6 for Nₚ:Nₛ₁:Nₛ₂, a transformer leakage inductance Lₗₖ of 1.46 pH, a transformer magnetizing inductance Lₘ of 2.45 mH, and an input/output DC link capacitor ratio Cᵢₙ/Cₒᵤₜ of 300 μF/300 μF.

In the illustrated embodiment, the controller 1502 is a Delfino-F28379D, 200 MHz DSP controller used to control the gate driving signals. As well, in the illustrated embodiment, the high frequency, high voltage AC signals are measured using the P5200 differential voltage probes from Tektronix. The high frequency current was measured using the CWT UM/03/B/1/80 AC probe from GMW. To display the waveforms, the DSOX2024 A 4-channel oscilloscope from Keysight was used. The impedance of the custom-made magnetic elements was validated using a Bode 100 impedance analyzer. The type, make and/or model of the various devices are identified here as examples only.

In the illustrated embodiment, a PSB 11000-80 4U power supply from EA was connected to Vᵢₙ terminals of the DAB converter to supply the 800V. The output Vₒᵤₜ terminals were connected to a 10 kW resistive load bank. The switches for primary and secondary bridges comprised of MOSFETs, such as, for example, the IMZ120R045M1 CoolSiC MOSFET from Infineon.

To ensure no saturation occurred inside the transformer core at severe operational conditions (either extreme bucking or boosting), DC blocking capacitors are placed in series with the transformer winding to mitigate DC current levels.

In at least one embodiment, the silicon-carbide (SiC) based DAB converter experimental prototype achieved an efficiency of 98% and a reduction in the total needed power components kVA ratings by 160% compared to conventional converters.

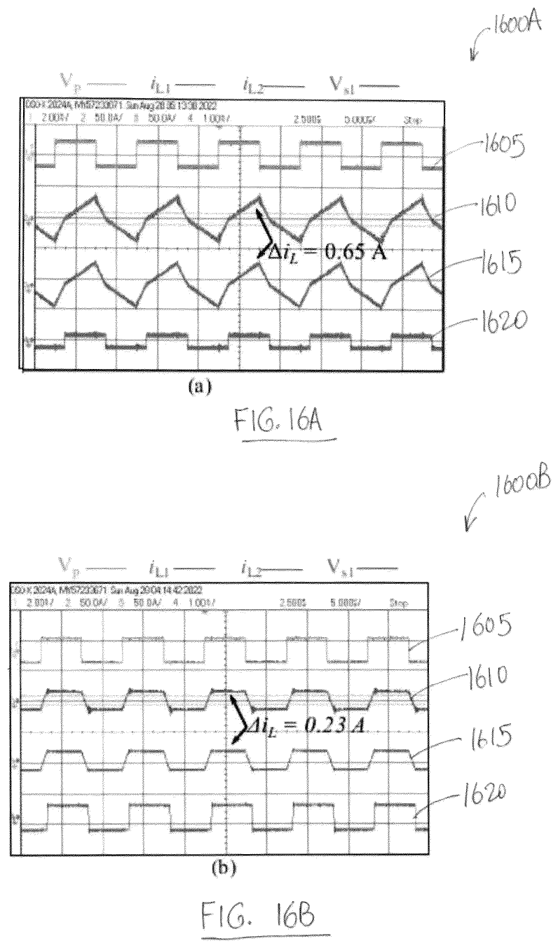

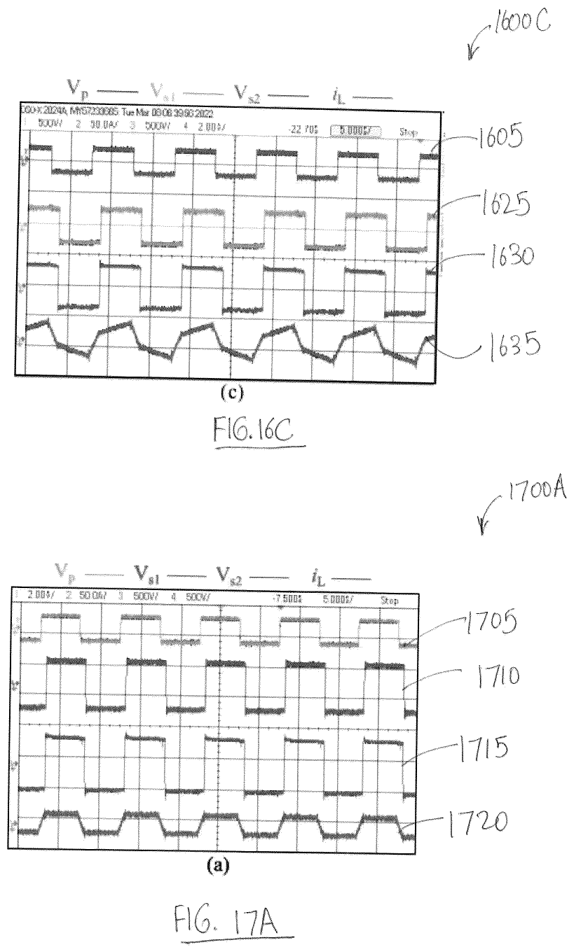

Reference is next made to FIGS. 16A-16C, which illustrate a graphical representation of the operation of a 10 kW DAB converter operation while changing output charging voltage from 200V to 600V in 200V increments. The input voltage in the illustrated embodiments is 800V. The output voltage Vₒᵤₜ in FIG. 16A is 200V, in FIG. 16B is 400V and in FIG. 16C is 600V. The converter is in the p-mode for the first two lower voltage points illustrated in FIGS. 16A and 16B, and in the s-mode for the embodiment of FIG. 16C. The converter switches to the s-mode in FIG. 16C since Vₒᵤₜ>V_{T,opt}.

Plot 1605 of FIGS. 16A, 16B and 16C represent the primary winding voltage Vₚ. Plot 1610 of FIGS. 16A and 16B represent the secondary current i_{L1} of the first secondary sub-circuit, such as sub-circuit 210 of FIGS. 2A-2C. Plot 1615 of FIGS. 16A and 16B represents the secondary current i_{L2} of the second secondary sub-circuit, such as sub-circuit 215 of FIGS. 2A-2C. Plot 1620 of FIGS. 16A and 16B represents the secondary winding voltage corresponding to the first secondary sub-circuit, such as sub-circuit 210 of FIGS. 2A-2C.

Plot 1625 represents the secondary winding voltage corresponding to the first secondary sub-circuit, such as sub-circuit 210 of FIGS. 2A-2C. Plot 1630 represents the secondary winding voltage corresponding to the second secondary sub-circuit, such as sub-circuit 215 of FIGS. 2A-2C. Plot 1635 represents the primary current i_{L}. Also shown in FIG. 16C, the two secondary voltages Vₛ₁ and Vₛ₂, as shown in plots 1625 and 1630, match, thus validating the symmetric operation and low device stress.

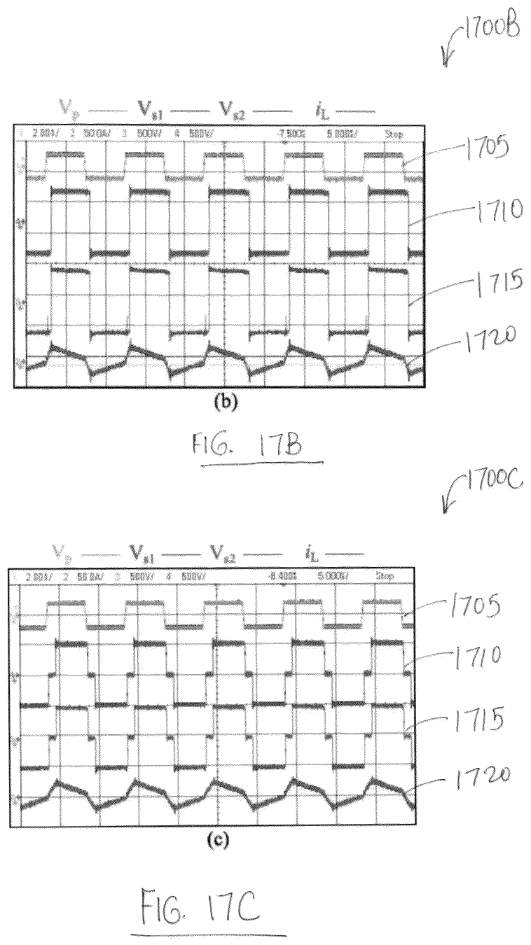

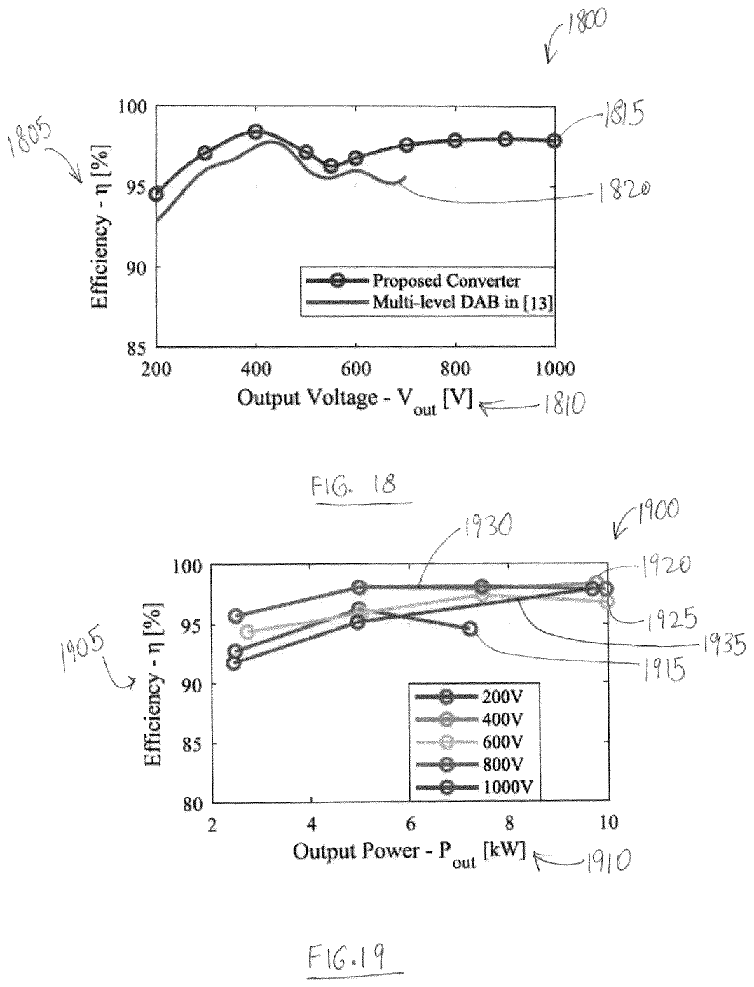

Reference is next made to FIGS. 17A-17C, which illustrate a 10 kW DAB converter operation at two output voltage levels, 800V (in FIG. 17A) and 1000V (in FIGS. 17B and 17C). FIG. 17B shows a DAB converter at 1000V with single-phase shift (SPS) modulation and FIG. 17C shows a DAB converter at 1000V with triple-phase shift (TPS) modulation. The converter is in the s-mode for all three points shown in FIGS. 17A-17C.

Plot 1705 of FIGS. 17A-17C represents the primary winding voltage Vₚ. Plot 1710 represents the secondary voltage corresponding to the first secondary sub-circuit, such as sub-circuit 210 of FIGS. 2A-2C. Plot 1715 represents the secondary voltage corresponding to the second secondary sub-circuit, such as sub-circuit 215 of FIGS. 2A-2C. Plot 1720 represents the primary current i_{L}.

In the embodiment of FIG. 17C, with TPS utilization, the DAB converter efficiency increases to 97.9% from the 95.8% realized in FIG. 17B. Also, in the embodiment of FIG. 17C, the converter operation is smoother compared to the operation illustrated in FIG. 17B, due to lower volt-sec stress on the magnetics.

Reference is next made to FIG. 18, which illustrate a graphical representation 1800 of efficiency 1805 realized by the DAB converter disclosed herein and a multi-level conventional DAB converter over a range 1810 of output voltage Vₒᵤₜ. The plots are generated based on testing done at the Pₒᵤₜ and Iₒᵤₜ limits of 10 kW and 36 A, respectively. Plot 1815 illustrates that as the output voltage is varied from 200V to 1000V in 100V steps, the DAB converter maintained a high efficiency of above approx. 95% for the full voltage range. For example, the efficiency of the DAB converter ranges from 95% to 98%. In contrast, the efficiency of the conventional DAB converter ranges between 93% to 97% approximately over the voltage range of 200V to 700V only.

Table III shows the current sharing error of the DC outputs in an experiment with a DAB converter running in the p-mode at a fixed output voltage of 400V and different power levels.

TABLE III
P-MODE CURRENT SHARING

| Iₒᵤₜ₁ [A] | Iₒᵤₜ₂ [A] | Pₒᵤₜ [kW] | Error [%] |
|---|---|---|---|
| 11.3 | 11.4 | 9.3 | 0.8 |
| 7.6 | 7.5 | 6.15 | 1.3 |
| 3.8 | 3.9 | 3.13 | 2.5 |
| 1.4 | 1.5 | 1.2 | 6.6 |

As seen in Table III, the output DC current sharing error is low and increases as the output power decreases. Referring to FIGS. 16A and 16B, the two secondary winding current i_{L1}, i_{L2} 1610, 1615 also illustrate a lower current sharing error as the maximum RMS current sharing error was evaluated to be 3.2%. In various embodiments, a current sharing error of about 3.2% is well within the acceptable range of DAB converter operation.

Reference is next made to FIG. 19, which illustrate a graphical representation 1900 of efficiency 1905 realized by the DAB converter over output power Pₒᵤₜ 1910 varied from ¼ load to full load (i.e. from 2 kW to 10 kW in the illustrated embodiment). In the illustrated embodiment, the RMS current minimization using TPS was implemented at low power to enhance the converter performance.

The plots 1915-1935 result from testing the DAB converter at five output voltage levels from 200V to 1000V. In particular, plot 1915 corresponds to output voltage Vₒᵤₜ of 200V, plot 1920 corresponds to output voltage Vₒᵤₜ of 400V, plot 1925 corresponds to output voltage Vₒᵤₜ of 600V, plot 1930 corresponds to output voltage Vₒᵤₜ of 800V and plot 1935 corresponds to output voltage Vₒᵤₜ of 1000V. Plots 1915-1935 demonstrate that maximum variation in the power efficiency of the DAB converter disclosed herein was maintained below 6% even at 1% load and an output voltage of 200V. The DAB converter proposed herein has the advantage of performance robustness over a wide operating range.

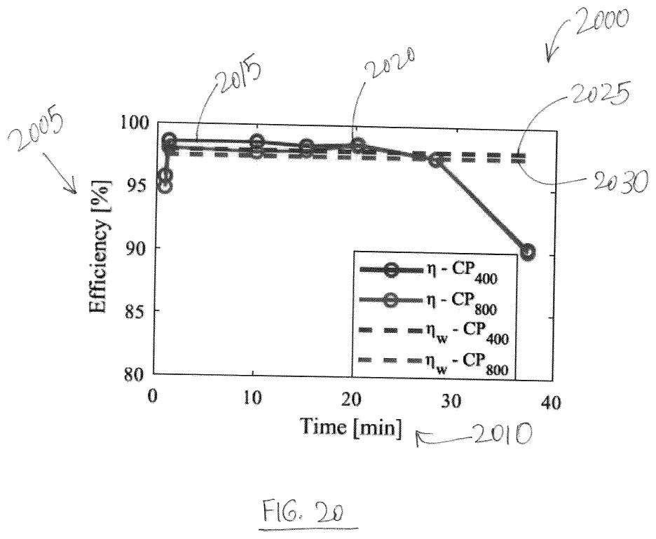

Reference is next made to FIG. 20, which illustrates a graphical representation 2000 of efficiency 2005 realized by the DAB converter over time 2010. The DAB converter is tested over two different charging profiles, i.e. CP₄₀₀ corresponding to 400V and CP₆₀₀ corresponding to 800V battery charging profiles. Plot 2015 corresponds to the CP₄₀₀ charging profile, and plot 2020 corresponds to the CP₆₀₀ charging profile. Plot 2025 corresponds to weighted energy efficiency for each charging session for a CP₄₀₀ charging profile. Plot 2030 corresponds to weighted energy efficiency for each charging session for a CP₆₀₀ charging profile.

FIG. 20 illustrates that even at the lowest voltage at the beginning of the charging session, the efficiency is above 95%. As well, the peak efficiency for both profiles is almost the same, reaching 98.4%. While the minimum efficiency is above 90.1% even at the end of the charging profile during low power charging at 1/10 of the rated load. Based on the weighted energy efficiency plots 2025, 2030 of FIG. 20, it is further illustrated that the CP₄₀₀ and CP₆₀₀ charging profiles can be charged at similar energy efficiencies of 97.9% and 97.5%, respectively.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

### Items

Item 1: A dual-active bridge (DAB) converter comprising: a primary sub-circuit coupled to a direct-current (DC) input voltage; a first secondary sub-circuit and a second secondary sub-circuit; a transformer isolating the primary sub-circuit from the first and the second secondary sub-circuits, and comprising a predetermined number of turns; each of the first and the secondary sub-circuits comprising a corresponding inductor; the first and the second secondary sub-circuits being configurable in a series mode and a parallel mode by switching configurations of a first, second and third transition switch; and the first and the second secondary sub-circuits providing an output charging voltage and an output charging current for charging an external device.

Item 2: The DAB converter of ay preceding item, wherein the primary sub-circuit consists of four bridge switches, and a primary winding having a corresponding primary winding voltage and primary current.

Item 3: The DAB converter of ay preceding item, further comprising a capacitor bank in parallel to the combination of the four bridge switches.

Item 4: The DAB converter of ay preceding item, wherein each of the first and second secondary sub-circuits comprise four bridge switches, a corresponding secondary winding having a corresponding secondary winding voltage and secondary current.

Item 5: The DAB converter of ay preceding item, wherein each of the first and second secondary sub-circuits further comprise a capacitor bank in parallel to the combination of the corresponding four bridge switches.

Item 6: The DAB converter of ay preceding item, wherein in the series mode, the first and the second secondary sub-circuits are connected in series and generate a higher output charging voltage than the parallel mode configuration.

Item 7: The DAB converter of ay preceding item, wherein in the parallel mode, the first and the second secondary sub-circuits are connected in parallel and generate a lower output charging voltage than the series mode configuration.

Item 8: The DAB converter of any preceding item, wherein the output charging voltage ranges from about 200V to 1000V.

Item 9: A charging station comprising: at least one charging pole; each charging pole comprising at least one DAB converter module according to the embodiments disclosed herein; wherein one or more electric vehicles are charged based on the output charging voltage of the corresponding DAB converter.

Item 10: The charging system of any preceding item, wherein one or more DAB converters of each charging pole are arranged in parallel to provide fast charging power to one or more electric vehicles.

We claim:

1. A dual-active bridge (DAB) converter, comprising:
a primary sub-circuit coupled to a direct-current (DC) input voltage;
a first secondary sub-circuit and a second secondary sub-circuit;
a transformer isolating the primary sub-circuit from the first and the second secondary sub-circuits, and comprising a predetermined number of turns;
each of the first and the secondary sub-circuits comprising a corresponding inductor;
the first and the second secondary sub-circuits being configurable in a series mode and a parallel mode by switching configurations of a first, second and third transition switch; and
the first and the second secondary sub-circuits providing an output charging voltage and an output charging current for charging an external device.

2. The DAB converter of claim 1, wherein the primary sub-circuit consists of four bridge switches, and a primary winding having a corresponding primary winding voltage and primary current.

3. The DAB converter of claim 2, further comprising a capacitor bank in parallel to the combination of the four bridge switches.

4. The DAB converter of claim 1, wherein each of the first and second secondary sub-circuits comprise four bridge switches, a corresponding secondary winding having a corresponding secondary winding voltage and secondary current.

5. The DAB converter of claim 4, wherein each of the first and second secondary sub-circuits further comprise a capacitor bank in parallel to the combination of the corresponding four bridge switches.

6. The DAB converter of claim 1, wherein in the series mode, the first and the second secondary sub-circuits are connected in series and generate a higher output charging voltage than the parallel mode configuration.

7. The DAB converter of claim 1, wherein in the parallel mode, the first and the second secondary sub-circuits are connected in parallel and generate a lower output charging voltage than the series mode configuration.

8. The DAB converter of claim 1, wherein the output charging voltage ranges from about 200V to 1000V.

9. A charging station comprising:
at least one charging pole;
each charging pole comprising at least one dual-active bridge (DAB) converter module, each DAB converter module comprising:
a primary sub-circuit coupled to a direct-current (DC) input voltage;
a first secondary sub-circuit and a second secondary sub-circuit;
a transformer isolating the primary sub-circuit from the first and the second secondary sub-circuits, and comprising a predetermined number of turns;
each of the first and the secondary sub-circuits comprising a corresponding inductor;
the first and the second secondary sub-circuits being configurable in a series mode and a parallel mode by switching configurations of a first, second and third transition switch; and
the first and the second secondary sub-circuits providing an output charging voltage and an output charging current for charging an external device;
wherein one or more electric vehicles are charged based on the output charging voltage of the corresponding DAB converter.

10. The charging station of claim 9, wherein one or more DAB converters of each charging pole are arranged in parallel to provide fast charging power to one or more electric vehicles.

11. The charging station of claim 9, wherein the primary sub-circuit of each DAB converter module consists of four bridge switches, and a primary winding having a corresponding primary winding voltage and primary current.

12. The charging station of claim 9, wherein each DAB converter module further comprises a capacitor bank in parallel to the combination of the four bridge switches.

13. The charging station of claim 9, wherein each of the first and second secondary sub-circuits of each DAB converter module comprise four bridge switches, a corresponding secondary winding having a corresponding secondary winding voltage and secondary current.

14. The charging station of claim 9, wherein each of the first and second secondary sub-circuits of each DAB converter module further comprise a capacitor bank in parallel to the combination of the corresponding four bridge switches.

15. The charging station of claim 9, wherein in the series mode, the first and the second secondary sub-circuits of each DAB converter module are connected in series and generate a higher output charging voltage than the parallel mode configuration.

16. The charging station of claim 9, wherein in the parallel mode, the first and the second secondary sub-circuits of each DAB converter module are connected in parallel and generate a lower output charging voltage than the series mode configuration.

17. The charging station of claim 9, wherein the output charging voltage ranges from about 200V to 1000V.
